(19) United States
(12) Patent Application Publication
(10) Pub. No.: US 2021/0161179 A1
(43) Pub. Date: Jun. 3, 2021

(54) APPARATUS AND METHOD TO DECONTAMINATE AGRICULTURAL PRODUCT UTILIZING OZONE

(71) Applicants: Thomas E. Merrow, Bloomsbury, NJ (US); Sara E. Morrison, Bloomsbury, NJ (US)

(72) Inventors: Thomas E. Merrow, Bloomsbury, NJ (US); Sara E. Morrison, Bloomsbury, NJ (US)

(21) Appl. No.: 16/700,721

(22) Filed: Dec. 2, 2019

(51) Int. Cl. A23L 3/3409; A23L 3/3445

(52) U.S. Cl. CPC A23L 3/34095; C01B 13/10; A23L 3/3445

(57) ABSTRACT

A method and apparatus to decontaminate agricultural products utilizing ozone gas. This invention achieved a 5-log or greater inactivation rate of surrogate organisms through a process of circulating ozone gas uniformly inside a hopper, conveyor assembly, and discharge box. The ozone gas distributes uniformly in the hopper through the operation of an agitator. The ozone gas, created by an ozone generator on-site, bifurcates inside a conveyor tube and distributes uniformly to the agricultural product inside a conveyor tube through the operation of a conveyor and a vibration motor. The conveyor assembly is air tight with safety measures operating to mitigate leakage of ozone gas. These safety measures include an ozone destructor or a perforated tube.

### FIELD OF INVENTION

The present invention relates to an agricultural product decontamination system that has a certified 5-log or greater inactivation rate of surrogate organisms through the process of circulating ozone gas inside a conveyor assembly with safety measures to mitigate leakage of ozone gas into the workspace or atmosphere.

### BACKGROUND OF INVENTION

Ozone (O₃) has been employed as a disinfectant for many years. Ozone possess an oxidation potential of 2.07 millivolts, which is superior to chlorine that has an oxidation potential of 1.36 millivolts. Ozone has approximately three times the oxidation potential as hydrogen peroxide. The greater oxidation potential of ozone translates to increases in rate of disinfection of bacteria: 3,000 times faster than chlorine. The effectiveness of ozone is matched by the high degree of versatility in its application. There is no evidence that any microorganism has developed resistance to oxidative bactericides; therefore, capable of prolonged application as a sanitizing agent.

Although ozone has found widespread usage in waste water recycling by the waste management industry and medical equipment sterilization industry, it has gained lackluster traction in the food processing industry. Meat, poultry, and agriculture products have been treated with aqueous ozone to extend their shelf-life. For the agricultural industry, gaseous ozone is used primarily during grain storage in silos, not food processing. Consequently, there is an unmet need to explore and design apparatus and methods that effectively utilize ozone gas in agricultural food processing.

Ozone is an environmentally friendly antibacterial agent, because it can be catalyzed to oxygen readily without any toxic byproducts. In 2001, the U.S. Food and Drug Administration formally approved the use of ozone as an Antimicrobial Agent for the Treatment, Storage, and Processing of Foods in Gas and Aqueous Phase. Furthermore, effective catalyst of ozone includes carbon and metal oxides, which are readily available and relatively inexpensive.

The use of ozone has its drawbacks. Because ozone is a highly reactive substance that can corrode most metals, the ozone destructor should be constructed with stainless steel or similar metals to maximize the longevity of the ozone destructor component. Ozone is a strong oxidizer; therefore, extremely dangerous when mishandled. FDA Regulation prohibits ozone levels to exceed 0.05 ppm of air in the space occupied by people. The predominant physiological effects of ozone range from irritation to pulmonary edema of the lung. Prolonged exposure yields a causal link to lung cancer. Excess ozone entering our environment also breaks down our atmosphere, exposing us to the harmful effect of UV radiation and skin cancer.

Although trained personnel recognize the problems and dangers of ozone exposure or leakage, this is often not enough. Many attempts failed to develop devices or machinery in the agricultural processing industry, with many uninspired attempts at containment, permitted a great deal of ozone to escape into the workspace and environment. The warnings of dangers led to the prevalence of ozone, and other oxidizers, to be used in an aqueous state, rather than a gaseous state. This amounts to a teaching away from the use of ozone gas, and opting for the use of ozonated water or other aqueous solvents.

For a maximum effect, the agriculture industry explored a range of aqueous disinfectant and pursued a course that led to the discovery of many aqueous oxidizing agents. In the 1970s, alcohol solvents, such as hydrogen peroxide and isopropanol, were deemed effective food sanitizing agents. As time progressed, a broad range of aqueous solvents were discovered, including sulfur dioxide and ammonia (U.S. Pat. No. 4,035,518), ultrasonic radiation and ethanol (U.S. Pat. No. 5,498,431), hydrogen peroxide vapor (U.S. Pat. No. 5,535,776), and cyanogen fumigation (U.S. Pat. No. 6,001,383). Recently, in November 2018, U.S. Pat. No. 10,136,642 issued to Dagher et al. discloses the use of peracetic acid administered in water for the treatment of growing plants. Similarly, in May 2019, U.S. Pat. No. 10,292,402 issued to Mathieu et al. discloses the use of an aqueous sanitizing agent comprising of water, biocidal agent, and alcohol solvents. The patents that utilize aqueous ozone include “Cold-Water Disinfection of Foods” (U.S. Pat. No. 6,200,618) issued to Smith et al. in 2001. This method comprises the use of both aqueous ozone and surfactant in a wash liquid to disinfect food.

The present invention achieved more than 5-log reduction in bacterial concentration with ozone alone (results certified). The current state of technology failed to reach this bar, achieving only a 3-log reduction in bacterial concentration utilizing ozone alone. Particularly, Smith disclosed that for bacterial spores (specifically, Bacillus subtilis v. globigii), ozone has been shown to achieve a 3-log reduction within 1.5 to 2 minutes, when water is purged with 3% ozone by weight. The best results occurred when food was wash in 15% ozone by weight in water for 1 to 60 minutes at a temperature between 0° C. and 30° C. Against E. coli, ozone resulted in merely 93% decrease of E. coli relative to control, and ozone in combination with surfactant resulted in a 98.8% decrease. In conclusion, Smith achieved only a 3-log reduction in bacterial spores and merely 93% decrease in E. coli relative to control, indicating the need for further research with ozone.

In contrast to ozonated fluid, attempts with the application of ozone gas as an antibacterial agent has also been lackluster at best. An absence of uniform exposure was a linchpin. Agriculture products such as grain or flour are miniscule; therefore, when stored in a silo or container, packs together tightly, leaving a small amount of air pockets for ozone to diffuse. The outer surface of grain or flour that actually contacts ozone molecules substantially diminishes under these conditions. Hence, while there may be ample concentrations of ozone gas in a silo or container, a small percentage of the ozone gas actually reaches its target or becomes effective.

Many attempts have been made to enhance the effectiveness of ozone gas as an antibacterial agent. In 1985, McCabe Jr. was issued a patent (U.S. Pat. No. 4,549,477) for an “Ozone Treatment System for Food.” The inventor created an enclosed chamber containing long, multiple conveyor belts configured in series to increase ozone gas surface contact with potato chips. McCabe Jr. also tried unsuccessfully to leverage the properties of ozone being 1.5 heavier than oxygen, hoping that ozone would not leak out from an open exhaust vent located on the top wall of the enclosure. The drawbacks were evident: long processing times and unmitigated ozone leakage.

The dichotomy of these two drawbacks proved to be formidable. In 2006, Walker et al. were issued a patent for a “Method and Apparatus for Ozonation of Grain” (U.S. Pat. No. 7,138,145). This invention utilized a fan placed at the bottom of the grain storage container to draw ozone (5 to 200 ppm) down through the grain. If the generator was unable to maintain a 100-ppm ozone concentration, the fan speed was reduced. While resolving the unmitigated ozone leakage problem, limiting applications to an enclosed silo manifested the drawback of long processing time. Specifically, the odor of mold and fungus disappeared after 24 hours; complete eradication of insects required 72 hours incubation with ozone.

In 2009, Klaptchuk was issued a patent for a Method of Destroying Seed (U.S. Pat. No. 7,501,550). An ozone source was coupled to a microwave emitter to simultaneously incubate the seeds in both ozone and microwave to kill seeds and pathogens. An auger conveyor carried the seeds through the process with ozone concentrations between 100 and 5,000 ppm (ozone to air) and oven temperature greater than 95° C. Although Klaptchuk solved the long processing time problem, the remaining problems comprised of ozone leakage and denaturing of nutritional value from the seeds.

In 2010, Noyes et al. were issued a patent for a “Method and Apparatus for Low-Energy In-Bin Cross-Flow Grain and Seed Air Drying and Storage” (U.S. Pat. No. 7,818,894). Noyes worked on creating a uniform ozone environment through cross-flow air movement. Vertical or horizontal aerator tubes were used to deliver an airflow speed between 100 and 200,000 cubic feet/min to dry the grain or introduce pathogen sterilization gas. However, this patent does not claim any means to catalyze ozone, but rather indicated that exhaust might free flow out through roof exhaust vents. Consequently, this results in unmitigated ozone leakage into our environment.

In 2017, Zwijack was issued a patent for an “Apparatus and Method for Decontaminating Grain” (U.S. Pat. No. 9,560,860). This invention is a free-fall chamber with a plurality of baffles and ozone ports that introduce a uniform concentration of ozone throughout a decontamination chamber. The baffles are reversed V-shaped or concave-shaped to divert the gravity driven flow-path of grain across the ozone ports without clogging it. The use of a plurality of baffles and ozone ports are substantially different means implemented by the present invention.

In 2018, Johnson et al. were issued a patent entitled, “System and Method for Continuous Flow Ozone Treatment of Grain” (U.S. Pat. No. 9,961,915). Johnson stated, the characteristics of grain in a bulk container were diverse; therefore, a system that customized treatment into sections enhanced grain quality. Unlike the Zwijack patent, this invention physically separated the grain into different silos and passed them through different concentrations of ozone in a daisy-chain fashion. The transfer of grain into different silos were continuous. Likewise, this apparatus does not utilize a conveyor system, focused on silos, thus different from the present invention.

Other means to treat agricultural products, which does not utilize ozone gas, include heat treatment. U.S. Pat. No. 9,961,915 issued to Johnson et al. in 2018 disclosed the decontamination of aflatoxin from seed by microwaving radiation to a temperature from 110° C. to 200° C. for a period of 15 to 45 minutes. This was a successful solution in killing bacteria, but it has major drawbacks. Heat application has the unfortunate consequence of denaturing the product, impacting its color, flavor, and nutritional value. Furthermore, heat treatment requires a tremendous amount of energy for processing, and therefore, not cost effective.

An unmet need exists in the agriculture industry for an agricultural food decontamination system that circulates ozone gas through a conveyor assembly to sterilize microorganisms with an effective kill rate of 5-log or more cfu/g (colony-forming units per gram), effective run time of 10 seconds, and effective safety mechanism to mitigate leakage of ozone gas into the workspace and atmosphere.

### SUMMARY OF THE INVENTION

The present invention is an agricultural food decontamination system that circulates ozone gas through a conveyor assembly to sterilize microorganisms with an effective kill rate of 5-log or more (cfu/g), effective run time of 10 seconds, and effective safety mechanism to mitigate leakage of ozone gas into our environment.

This invention is an integrated system with an ozone generator that pneumatically injects ozone gas into a conveyor tube. The conveyor tube is one of many sterilizing chambers in the system. Other sterilization chambers include a hopper, discharge box, and perforated tube. The ozone generator is regulated by a system controller that modulates ozone output until a threshold level of ozone concentration is reached within one or more of sterilization chambers. In a preferred embodiment, the threshold level of ozone gas concentrations in the conveyor tube is at least 14,000 ppm.

While the system controller and the ozone generator may be housed separately, in a preferred embodiment, these components are housed together as a single unit for efficiency purposes. There are two pneumatic drivers: ozone generator and exhaust fan. The ozone generator injects ozone gas through an ozone generator pipe into the conveyor tube to create positive air pressure, while the exhaust fan draws air into an exhaust vent to create negative air pressure. The combination of these two air pressures dictate ozone gas concentrations in the sterilization chambers.

Choosing the best type of conveyor is dependent on many variables such as whether the agricultural product is free-flowing or non-free flowing (e.g., seeds, grains, flour); whether the product is fragile or delicate (e.g., freeze dried fruit, dried fruits). As a guideline, a round screw conveyor is utilized to transport free-flowing product. A beveled screw conveyor is utilized to transport flours. A puck conveyor is utilized to transport delicate fruits.

Parameters, such as length and speed of the conveyor, set the conditions of operation, including run time. In a preferred embodiment, the run time is between 5 and 60 seconds. This value is a function of ozone exposure required to yield an effective kill rate of 5-log or more (cfu/g).

The system controller is in continuous communication with the ozone generator, conveyor, and exhaust fan. Through ongoing sensors readings, the system controller receives and displays the status of microenvironments and operating parameters. The system controller may automatically maintain threshold concentrations of ozone within the sterilization chambers by adjusting ozone generator flow rates, conveyor transport speed, or exhaust fan output.

Ozone enters the conveyor tube from a centrally located conveyor tube inlet. Thereafter, the ozone gas bifurcates diametrically: upward toward a discharge box and downward toward a hopper. Within the conveyor tube, ozone saturates and disinfects the agricultural product. To maximize ozone contact with the agricultural product's surface area, a vibration machine is attached to the conveyor tube. The vibration machine, though not required, is preferred because the conveyor itself stirs the grain during operation.

As the agricultural product enters a discharge box, gravity pushes the grain downward into a discharge transition, which direct the grain into a container. Simultaneously, as the grain falls downward, negative air pressure from the exhaust fan pulls the ozone gas commingled with the grain upward. The discharge box strives to separate all of the ozone from the agriculture product; however, this may not be enough.

A portion of the ozone gas flowing colinearly with the falling grain may escape. The impetus is an independently created air flow generated by the falling grain. The solution proposed by this invention is a perforated tube, acting as an intermediary, between the discharge transition and the storage container. In effect, the perforated tube extends and enhances the opportunity of upward air flow, capturing a greater amount of ozone gas, minimizing ozone leakage into the workspace and environment. A customized selection is encouraged to ensure sufficient tube perforations and length to capture most, preferably all, of the ozone gas before the agricultural product exits the perforated tube.

Once the ozone is shunted through the ozone vent of the discharge box, the ozone is guided into an ozone destructor, which catalyzes highly reactive trioxygen molecule O₃ to innocuous oxygen O₂. In a preferred embodiment, the catalyst is manganese dioxide and copper oxide.

The ozone destructor connected to an exhaust vent inlet. In a preferred embodiment, the connector is a duct hose. An exhaust fan mounted to an exhaust vent generates negative air pressure to draw the catalyzed ozone, i.e., oxygen, into the exhaust vent. The oxygen is either recirculated as conditioned air or vented outside.

As mentioned above, ozone enters the conveyor tube from a centrally located conveyor tube inlet. Thereafter, the ozone gas bifurcates diametrically: upward toward the discharge box and downward toward the hopper. When the ozone moves downward, ozone gas similarly sanitizes the agricultural product in the conveyor tube along the way. The conveyor tube is removably attached to a hopper tube junction 6 and typically fixed in position with one or more bolts. Ozone flows into the hopper through the hopper tube junction 6 located at the base of the hopper funnel.

During operations, the hopper funnel functions as a reservoir for agricultural product, such as grains, seeds, flours, fruits, and fresh produce. Although the ozone can percolate through a bed of grain, localized packing or clumping of grain impedes uniform exposure to ozone. Therefore, in a preferred embodiment, an agitator having an agitator motor is utilized to stir the grain collected inside the hopper reservoir. In a preferred embodiment, an agitator motor with a plurality of agitator blades connected to an agitator shaft rotates axially. This configuration permits antibacterial activity to begin as soon as the agricultural product enters the hopper.

To evacuate the ozone gas, a hopper exhaust port directs the flow of ozone from inside the hopper reservoir to an ozone destructor. Although the drawings depict two ozone destructors, a single ozone destructor with adequate capacity is within the scope of this invention. One or more ozone destructors are connected to an exhaust vent inlet. The connector is either a fixed or flexible duct hose. The negative pressure driving the flow of oxygen into the exhaust vent is generated by an exhaust fan. Thereafter, the Ozone clean oxygen inside the exhaust vent is either recirculated as conditioned air or diverted outside.

Now referring to the flow of agricultural product, it enters a hopper orifice located on the top wall of the hopper. Flow of grain from a single batch is continuously delivered into the hopper. Once the grain is inside the hopper, the presence of ozone gas begins to sterilize or disinfect the agricultural product of bacteria, fungus, or other microorganisms. The grain is stirred by an agitator attached to the hopper funnel side wall to enhance surface area contact. A conveyor tube connected to the hopper houses a conveyor.

As mentioned above, the selection of conveyor type (e.g., screw conveyor, puck conveyor, or bevel conveyor) is dependent on the multiple variables, such as how fragile is the agricultural product, its free-flowing value, and ozone exposure requirements. The conveyor is attached to a gear box actuated by a conveyor motor. The motor controller is preferably a variable frequency drive (VFD), to minimize conveyor changeovers.

As the grain enters the discharge box connected to the conveyor tube, the grain is propelled into the cavity of the discharge box. Subject to gravity, the grain free falls through an opening on the discharge transition located on lower portion of the discharged box. The discharge transition is tapered to minimize building up inside the cavity and connected to a perforated tube. As mentioned, the perforated tube functions as a transition compartment to capture a greater amount, preferably all, of the ozone gas before the grain leaves the perforated tube. Consequently, little if any ozone leaks into the workspace or contaminates our environment.

### BRIEF DESCRIPTION OF THE INVENTION

The embodiments set forth in the figures of the accompanying drawings are illustrated by way of examples, and not by way of limitations. While the claims distinctly point out the present invention, the following drawings and description taken in conjunction aids in the understanding of the invention:

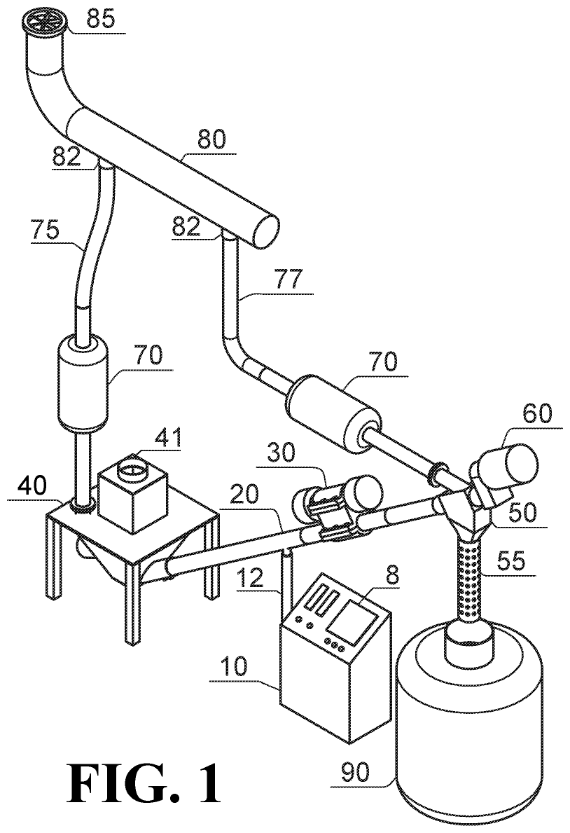

FIG. 1 is a north east perspective view of an exemplary agricultural food decontamination system utilizing a screw conveyor.

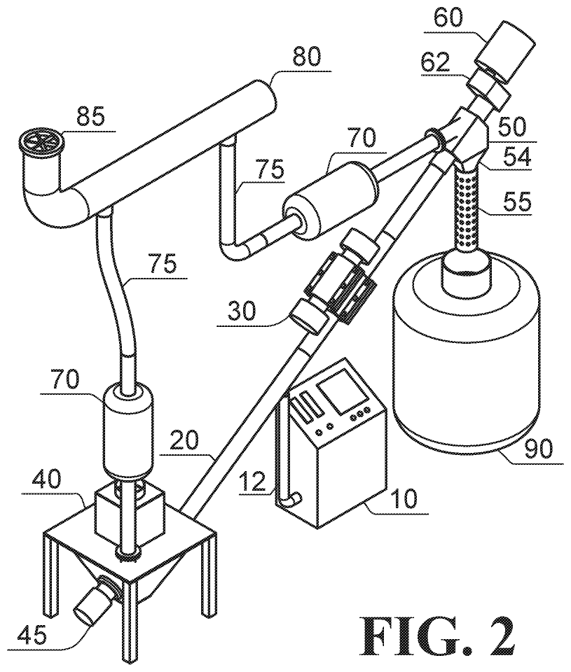

FIG. 2 is a north west perspective view of an exemplary agricultural food decontamination system illustrated in FIG. 1.

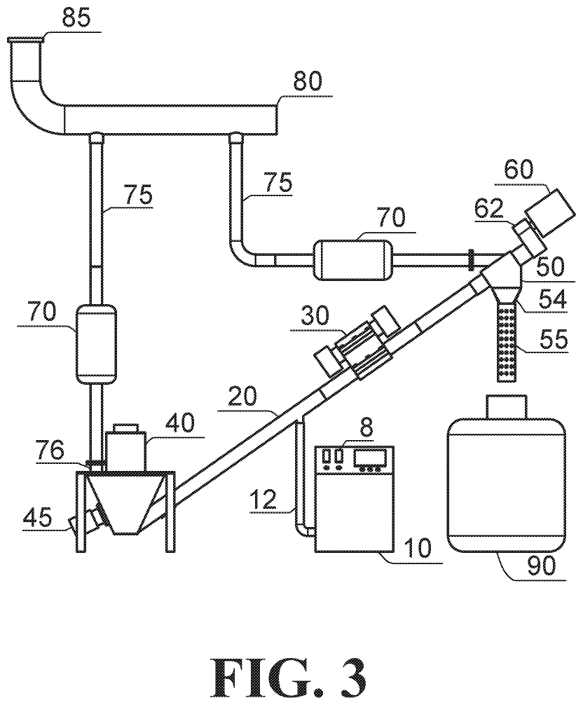

FIG. 3 is a side view of an exemplary agricultural food decontamination system illustrated in FIG. 1.

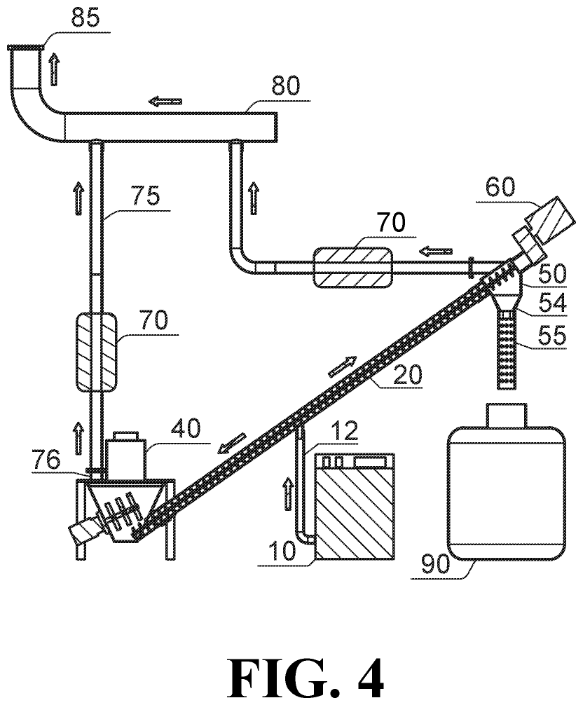

FIG. 4 is a sectional view illustrating direction of ozone gas flow throughout the agricultural food decontamination system illustrated in FIG. 3.

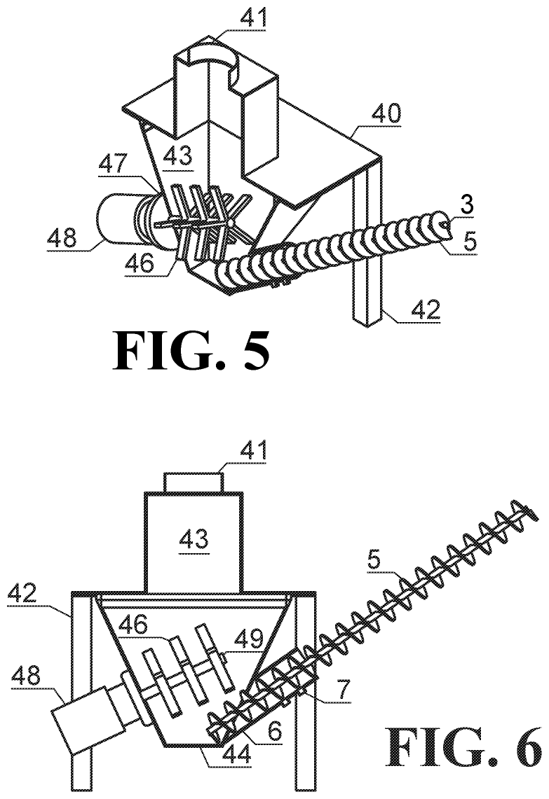

FIG. 5 is a cutaway illustration of an agitator and a conveyor connected to a hopper.

FIG. 6 is a sectional side view of the hopper and assembled components illustrated in FIG. 5.

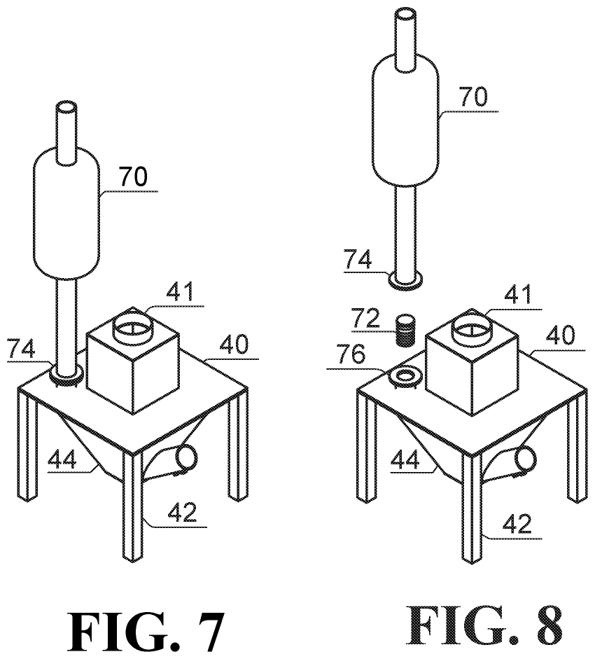

FIG. 7 is a perspective view of a hopper and an ozone destructor assembled through a flange joint.

FIG. 8 is an exploded view of the drawings illustrated in FIG. 7, displaying an ozone destructor elevated from a hopper, revealing the presence of a filter.

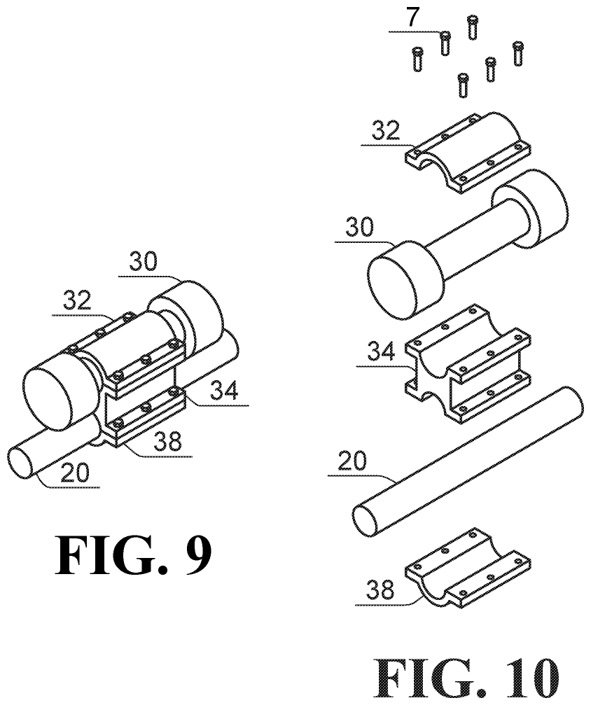

FIG. 9 is a perspective view of an exemplary vibration motor in an assembled configuration.

FIG. 10 is an exploded view of the vibration motor depicted in FIG. 9, illustrating the following components: fasteners, a top cap, a vibration motor, a bracket, a conveyor tube, and bottom cap.

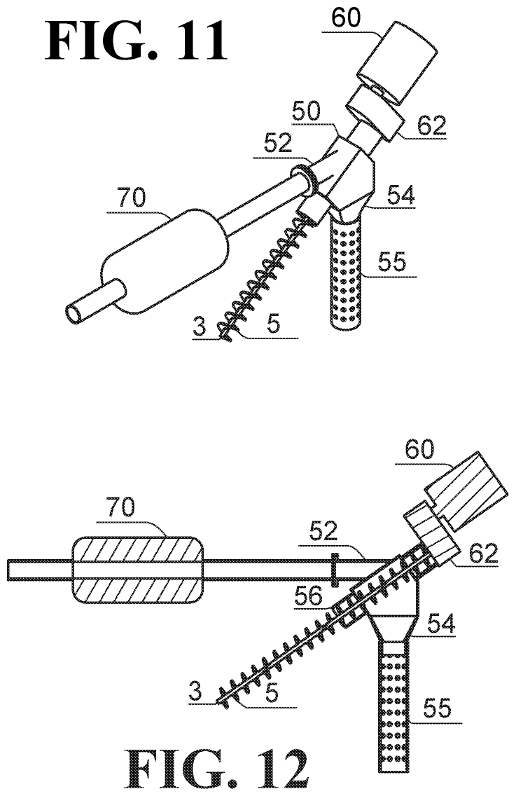

FIG. 11 is a perspective view of a discharge box with the following components attached: gear box, conveyor motor, perforated tube, conveyor tube, and ozone destructor.

FIG. 12 is a section view of the discharge box illustrated in FIG. 11, likewise illustrating the following components attached: gear box, conveyor motor, perforated tube, conveyor tube, and ozone destructor.

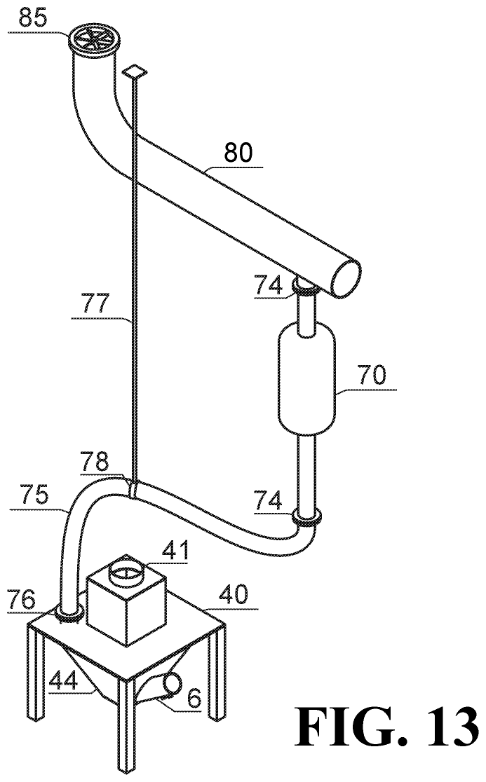

FIG. 13 is a perspective view of a hopper connected to an ozone destructor by a flexible duct hose, wherein the duct hose is supported by a strap and a ceiling rod.

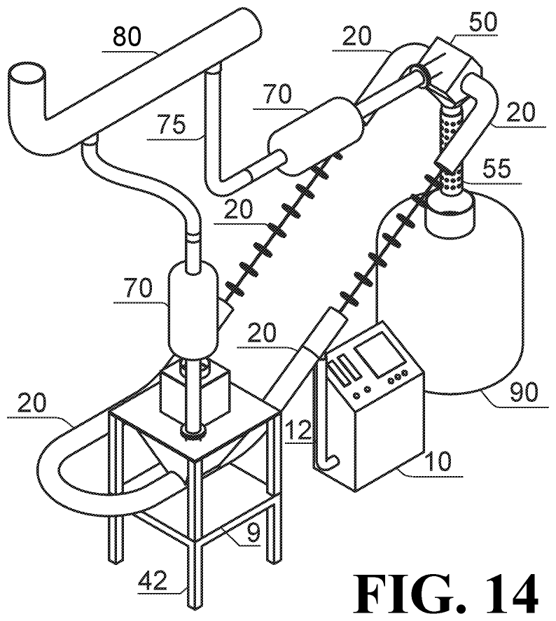

FIG. 14 is a perspective view of an exemplary agricultural food decontamination system utilizing a puck conveyor. This diagram further exemplifies how the hopper is elevated by taller legs, and how hopper stability is enhanced with a table approximately midplane of the leg height.

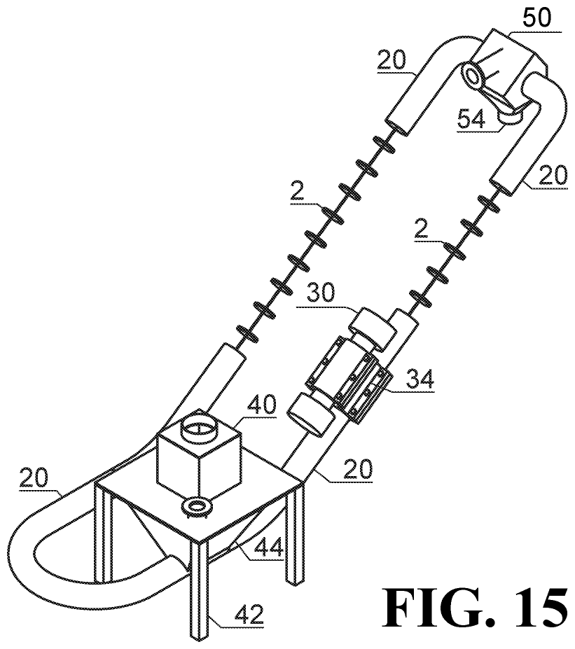

FIG. 15 is a perspective view of an exemplary agricultural food decontamination system utilizing a puck conveyor with a vibration motor attached to the conveyor tube.

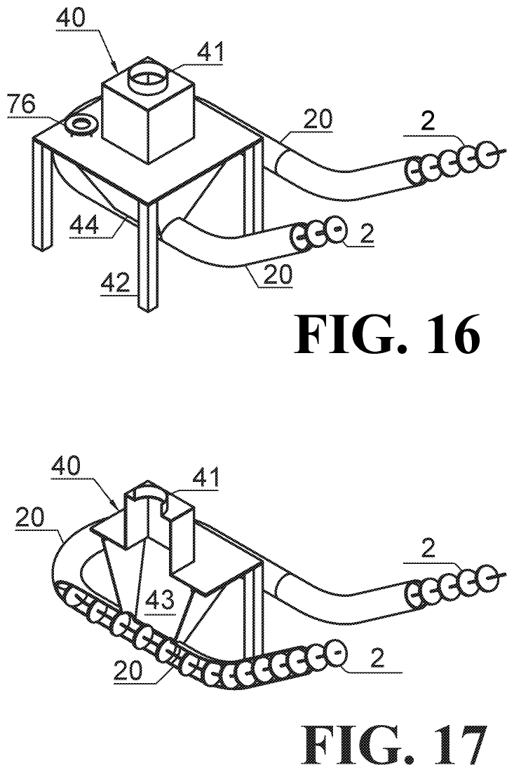

FIG. 16 is a perspective view of an exemplary agricultural food decontamination system utilizing a puck conveyor with pucks circulating along the conveyor tube pathway.

FIG. 17 is a cutaway illustrating an opening along the hopper funnel base, which permits agricultural product stored in the hopper reservoir to enter between the pucks and carried at an incline toward the discharge box.

### DETAILED DESCRIPTION OF THE INVENTION

The invention relates to an agricultural food decontamination system that has a certified 5-log or greater inactivation rate of surrogate organisms through a process of circulating ozone gas inside a hopper, conveyor assembly, and discharge box. Safety measures to mitigate leakage of ozone gas, includes at least one ozone destructor or perforated tube.

FIGS. 1-4 illustrate an embodiment of the agricultural food decontamination system. A system controller 8 receives sensor information and regulates components of the agricultural food decontamination system. These components include an ozone generator 10, conveyor system, vibration motor 30, hopper 40, ozone destructor 70, discharge box 50, discharge transition 54, perforated tube 55, container 90, gear box 62, conveyor motor 60, exhaust vent 80, and exhaust fan 85.

The ozone generator 10 creates ozone on-site. The ozone is produced by adding energy to oxygen molecules (O₂) to create ozone (O₃). This process can occur through coronal discharge or ultra-violet bulbs. The ozone generator 10 delivers ozone to the conveyor tube 20 through an ozone generator pipe 12 connected to a centrically located conveyor tube inlet. These junctions are air tight to prevent leakage of ozone into the work area.

The ozone generator 10 output requirements are dependent upon the scale of operation. The minimum ozone flow rate is calculated based on the time required to achieve an ozone concentration of at least 14,000 ppm inside the conveyor tube 20. In a preferred embodiment, the ozone gas infeed is activated for 10 seconds before agricultural product starts flowing into the conveyor system.

The conveyor system, specifically conveyor tube incline, raises the agricultural products to heights convenient for its next stage of processing (e.g., discharge box 50 separation activities). The steepness of its route and distance traveled has a direct impact on the duration agricultural products are exposed to ozone in the conveyor tube 20. Likewise, conveyor speed can shorten or lengthen the duration agricultural products are exposed to ozone in the conveyor tube 20. Extended duration means a greater absolute expose to ozone treatment; therefore, greater opportunities for ozone sterilization of microorganisms. The tradeoff with a longer run time is productivity, i.e., the amount of grain that can be processed daily. In a preferred embodiment, the conveyor run time is between 5 and 60 seconds. In another preferred embodiment, the conveyor run time is 10 seconds.

To enhance ozone exposure without sacrificing productivity, a vibration motor 30 is added. The vibration motor 30 functions to agitate the agricultural product so it levitates, enhancing surface area availability and contact with ozone gas. The vibration motor 30 assembly has six components: bracket 34, vibration motor 30, top cap 32, conveyor tube 20, bottom cap 38, and fasteners. The bracket 34 has two grooves, a top groove and a bottom groove. The top cap 32 also has an arch. When assembled together, the top groove of the bracket 34 and arch of the top cam conform to the shape of the vibration motor 30. In a preferred embodiment, the top groove and arch are circular, thus together creates a snug cylindrical joint with the vibration motor 30. A plurality of fasteners clamps the vibration motor 30 to the top cap 32 and bracket 34 in place. In a preferred embodiment, the fasteners consist of six bolts 7. In a similar manner, the bottom groove of the bracket 34 and bottom cap 38 conform to the shape of the conveyor tube 20, which collectively fasten together to fix its position. The addition of a vibration motor 30, while preferred, is not required because the churning created by the motion of the conveyor (e.g., screw conveyor 5, puck conveyor 2) may be sufficient.

Choosing the best conveyor is based on several considerations, including the agricultural product being processed, its viscosity and fragility. A screw conveyor 5 is preferred for free-flowing or non-free flowing products (e.g., seeds, grains, flours). Specifically, a round screw conveyor is used for free-flowing product. A beveled screw conveyor is used for flour. For delicate product (e.g., freeze dried fruits, dried fruit) a puck conveyor 2 is used.

A hopper 40 functions as a reservoir for the continuous distribution of grain into the conveyor tube 20. The hopper reservoir 43 has a top portion and bottom portion. The top portion of the hopper 40 has a hopper orifice 41 that allows a continuous flow of grain to enter the hopper reservoir 43. The bottom portion of the hopper reservoir 43 is tapered to fashion a hopper funnel 44. At the base of the hopper funnel 44 resides a hopper tube junction 6, which enables connectivity between the conveyor tube 20 and the hopper 40. One or more bolts 7 are used to create a rigid joint between the conveyor tube 20 and the hopper 40.

The height of the hopper tube junction 6 from the ground is modulated by legs 42 that elevate the hopper 40. The legs 42 function to provide flexibility and variations in conveyor tube 20 length, so potential leakage of ozone is averted. In a preferred embodiment, a table 9 positioned approximately mid-plane of the distal leg 42 height surfaces, improves sturdiness of the legs 42 and stability during operation. Further benefits include added storage space.

In a preferred embodiment, an agitator motor 48 is secured to the funnel side wall with an agitator gasket 47 to form an air tight seal. The purpose is to create an enclosure that prevents leakage of ozone into the workspace or atmosphere. The agitator 45, comprising of an agitator motor 48, agitator shaft 49, and agitator blades, 45 functions to stir the agricultural product stored temporarily inside the hopper reservoir 43. A plurality of agitator blades 46, extending from the agitator shaft 49, spin axially to mix the ozone gas with the agricultural product. The mixing process ensures a uniform distribution of ozone throughout the hopper reservoir 43.

As the agricultural product sits in the hopper 40, waiting to be transported by the conveyor, valuable time passes. This invention seizes that knowledge and leverages that time to begin treatment of the agricultural product with ozone gas. Maximizing efficiency opportunities has yielded greater than 5-log reduction in bacteria concentrations (cfu/g) with run time between 5 and 60 seconds. The certification methodology and results are provided below.

The hopper 40 has a hopper exhaust port 76 that allows ozone gas to exit the hopper reservoir 43. In a preferred embodiment, the hopper exhaust port 76 has a flanged fitting 74 to create an air tight seal between the hopper 40 and the ozone destructor 70. Various interlocking seals, clamps, or suitable substitutes known to the art are deemed substantially equivalent or interchangeable options, falling within the scope of this invention.

Secured to the hopper exhaust port 76 is a filter 72, which screens the agricultural product, including grain or seed dust, to prevent particulate matter from entering the ozone destructor 70 and the exhaust vent 80. Selecting the type of filter 72, namely with appropriate microns filtration rating, depends on the agricultural product being processed. For example, grain is likely to product finer dust particles than fruit, so a filter 72 with smaller pores removes more dust particles.

The discharge box 50 is a ventilation system that has four branches, which leads to the (1) conveyor tube 20, (2) conveyor motor 60, (3) ozone vent 52, and (4) discharge transition 54. The conveyor junction 56 and the conveyor motor 60 are generally located on opposing ends of the discharge box 50. Likewise, the ozone vent 52 and the discharge transition 54 are generally located on opposing ends of the discharge box 50. As the agricultural product enters the hollow cavity of the discharge box 50, gravity motions the grain downward toward the discharge transition 54. In a preferred embodiment, the discharge transition 54 is tapered to form a circular port, which interlocks with a perforated tube 55.

Negative air pressure traversing the ozone vent 52 pulls ozone gas and air upward. The negative air pressure created by an exhaust fan 85 separates ozone gas from falling grain in the discharge transition 54 and the perforate tube 55. The amount of air flow traveling through the ozone vent 52 is set to meet the demands of various applications. In some situations, such as with grain, its high surface area and fast flowing nature cause ozone to travel colinearly with the grain. Hence, a higher air flow is required to deflect and divert the ozone upward into the ozone vent 52.

A perforated tube 55 is used to extends the transition distance between the discharge transition 54 and the container 90. A plurality of apertures on the perforated tube 55 create cross stream paths on multiple planes and enhance ozone gas separation from downward traveling grains. In a preferred embodiment, the perforated tube 55 selected is determined by sensor readings that monitor the amount of ozone present in the discharge box 50, discharge transition 54, perforated tube 55, or container 90.

The conveyor traverses the length of the discharge box 50 to connect with a gear box 62 attached to a conveyor motor 60. The conveyor motor 60 drives the rotating conveyor shaft 3 of a screw conveyor 5 or pulls the rope of a puck conveyor 2 assembly. In a preferred embodiment, the conveyor motor 60 speed is modulated by a variable frequency drive (VFD). The VFD characteristics of shifting torque and power levels enable a conveyor (e.g., screw conveyor 5) used in a previous run to perform a broader range of food processing. Consequently, this versatility minimizes the effort needed for conveyor change over for subsequent processing of different categories of products.

The ozone vent 52 or hopper exhaust port 76, independently or simultaneously, connects to one or more ozone destructors 70. The ozone destructor 70 reduces reactive ozone (O₃) to unreactive oxygen (O₂) as it passes through a catalyst. Conventional catalyst known by a person of ordinary skill in the art includes charcoal and metal oxides. In a preferred embodiment, the catalyst is manganese dioxide and copper oxide. The stream of oxygen emitted from the ozone destructor 70 may be safely returned to the atmosphere through an exhaust vent 80.

A duct hose 75 is used to connect the ozone destructor 70 to an exhaust vent inlet. In a preferred embodiment, the duct hose 75 is flexible to avoid interference with grain delivery mechanisms leading to the hopper 40. FIGS. 1-4 depict a sequence of a hopper 40, connected to an ozone destructor 70, connected to duct hose 75, connected to an exhaust vent 80. FIG. 13 illustrates a preferred embodiment, wherein the sequence is interchangeable: the hopper 40 is connected to a duct hose 75, connected to an ozone destructor 70, connected to an exhaust vent 80. The later sequence is preferred, because the ozone destructor 70 housing is more rigid than a flexible duct hose 75. Therefore, fixing the ozone destructor 70 to the exhaust vent 80 in the proximity of the ceiling is an ideal configuration to minimize interference.

FIG. 13 further illustrates the presence of a strap 78 and ceiling rod 77 supporting the duct hose 75. An exhaust fan 85 within the exhaust vent 80 generates negative pressure that drives the flow of oxygen through the exhaust vent 80. Instructions provided to the system controller 8 signals the exhaust fan 85 to increase or decrease the speed of air streaming into the exhaust vent 80. In a preferred embodiment, an ozone sensor is used to measure the amount of ozone or oxygen reaching the end of the exhaust vent 80 to ensure complete transformation of ozone to oxygen by the ozone destructor 70. In the event an ozone sensor signals the presence of ozone in the exhaust vent 80, the air flow generated by the exhaust fan 85, ozone created by the ozone generator 10, or conveyor speed transporting the agricultural product may be reduced, through the system controller 8, to compensate for capacity limit of the catalyst in the ozone destructor 70.

### Certification Study #1

To determine the level of inactivation of surrogate organisms in the processed agricultural product, the following experimentation were performed. The overall purpose of this study is to investigate the survival of surrogates for Salmonella and pathogenic E. coli in agricultural ingredients after being exposed this inventive apparatus and process.

Samples of agricultural ingredients (i.e., pumpkin seeds, teff flour, and quinoa) were inoculated with a stock solution of nonpathogenic E. coli and forwarded to a processing facility. The inoculated product was treated by this inventive apparatus or process, and then returned to Eurofins Microbiology Laboratories for enumeration.

Escherichia coli cultures (ATCC #BAA-1427 to 1431) were prepared from a fresh lyophilized preparation (American Type Culture Collection, Manassas, Va.) according to manufacturer's instructions. The cultures were transferred onto Tryptic Soy Broth (TSB, Neogen, Lansing, Mich.) and incubated 18-24 hours at 35±2° C. This stock was then combined into a cocktail and plated onto MacConkey Agar (MAC, Neogen Lansing, Mich.) and Tryptic Soy Agar (TSA, Neogen, Lansing, Mich.) at appropriate dilutions to verify the concentration of organism.

Agricultural ingredient samples (i.e., pumpkin seeds, teff flour, and quinoa) were supplied by Onset Worldwide. Samples of the product were aseptically weighed into sterile, plastic bags and 25 mL of the challenge preparation was added to a 400 g volume of product. The bag was closed and inverted by hand for 60 seconds. The inoculated products were poured out of the bag and spread onto two sheets of 46×57-cm filter paper (Fisherbrand Qualitative P8; Fisher Scientific, Pittsburgh, Pa.) which was folded in half and placed inside a sanitized plastic tub. Inoculated samples were dried for 24±2 hours at room temperature in a biosafety cabinet (Model A2, Labconco, Kansas City, Mo.). The target inoculum concentration was >10⁷ cfu/g. A total of 9 (25 g) inoculated samples of the product were prepared and forwarded to the processing facility for treatment, along with a set of 3 (25 g) uninoculated control samples.

The forwarded test samples were treated. A set of 3 post-treatment samples of each product were returned via overnight delivery to Eurofins Microbiology Laboratories. An additional set of 3 inoculated samples were left untreated and returned along with the treated samples as a positive control, while the 3 uninoculated untreated samples were returned as a negative control. Product samples were plated on MAC incorporating a thin agar layer of TSA to ensure the recovery of potentially injured organisms. TAL-MAC plates were incubated for 24-48 hours at 35±2° C. Each sample was plated using the lowest possible dilution to maximize the observed reduction. After incubation, all plates were enumerated by hand using a Quebec colony counter (Model 3325, Reichert, Inc., Depew, N.Y.).

Results for each sample were converted to log₁₀ cfu/g. Results of the enumerations for the treated samples were compared to the untreated control samples to determine the effect of the inventive apparatus and process on the challenge organism. The inventive apparatus and process were deemed to be successful at controlling the challenge organism if it reduces the inoculum in the product by a minimum of 5.0 logs.

Results for the inoculated samples are shown in Table 1 below, including type of product, observed result (in cfu/g) for each replicate, the average result for all replicates, the log₁₀ of the average, and (for treated samples) the reduction (in log₁₀ cfu/g) from the untreated control.

TABLE 1
Challenge Study Results 1

| Sample Type | Pumpkin Seeds | Teff Flour | Quinoa |
|---|---|---|---|
| Uninoculated Sample 1 | 10 | <10 | <10 |
| Uninoculated Sample 2 | <10 | <10 | <10 |
| Uninoculated Sample 3 | <10 | <10 | <10 |
| Average (cfu/g) | <10 | <10 | <10 |
| Pre-Treat Sample 1 | 158,000,000 | 64,000,000 | 84,000,000 |
| Pre-Treat Sample 2 | 90,000,000 | 118,000,000 | 79,000,000 |
| Pre-Treat Sample 3 | 118,000,000 | 59,000,000 | 94,000,000 |
| Average (cfu/g) | 122,000,000 | 80,333,333 | 85,666,667 |
| Log₁₀ | 8.09 | 7.90 | 7.93 |
| Post-Treatment Sample 1 | 310 | 670 | 120 |
| Post-Treatment Sample 2 | 940 | 930 | 130 |
| Post-Treatment Sample 3 | 1,010 | 730 | 820 |
| Post-Treatment Sample 4 | 670 | 530 | 100 |
| Post-Treatment Sample 5 | 820 | 460 | 140 |
| Post-Treatment Sample 6 | 580 | 1,020 | 130 |
| Average (cfu/g) | 722 | 723 | 240 |
| Log₁₀ | 2.86 | 2.86 | 2.38 |
| Reduction | 5.23 | 5.05 | 5.55 |

### Conclusion

Levels of E. coli were detected in all three products after treatment. However, all post-treatment results showed reductions (in log₁₀ cfu/g) greater than the 5.0 standard, indicating that they were effective in reducing the generic E. coli surrogate. No background E. coli was detected on the uninoculated samples.

The data in this study indicate the above-mentioned apparatus or process were effective at controlling a surrogate for Salmonella spp. and pathogenic E. coli. Reductions against each matrix examined, including pumpkin seeds, teff flour, and quinoa, were greater than 5.0 log₁₀ cfu/g post-exposure.

### Certification Study #2

Samples of agricultural ingredients (i.e., chia seeds, hulled hemp, cashews, defatted milled chia flour, and psyllium powder) were inoculated with a stock solution of nonpathogenic E. coli and forwarded to a processing facility. The inoculated product was treated with the above-mentioned apparatus or process at two separate exposure times, and then returned to Eurofins Microbiology Laboratories for enumeration. Additional uninoculated product (chia seeds) was microbiologically and chemically compared after being exposed to the above-mentioned apparatus and process both immediately after treatment and after a period of ambient storage.

Agricultural ingredient samples (i.e., chia seeds, hulled hemp, cashews, defatted milled chia flour, and psyllium powder) were supplied by Onset Worldwide. Samples of each product were aseptically weighed into sterile, plastic bags and 25 mL of the challenge preparation was added to a 400 g volume of product. The bag was closed and inverted by hand for 60 seconds. The inoculated products were poured out of the bag and spread onto two sheets of 46×57-cm filter paper (Fisherbrand Qualitative P8; Fisher Scientific, Pittsburgh, Pa.) which were folded in half and placed inside a sanitized plastic tub. Inoculated samples were dried for 24±2 hours at room temperature in a biosafety cabinet (Model A2, Labconco, Kansas City, Mo.). If any clumping of the product due to the use of a liquid inoculum was observed, clumps of dried inoculated material were aseptically ground and distributed through the remaining product as a solid to solid inoculation. The target inoculum concentration was >10⁷ cfu/g. A total of 9 (25 g) inoculated samples of each product were prepared and forwarded to the processing facility for treatment, along with a set of 3 (25 g) uninoculated control samples.

For the chia seed product, additional sets of uninoculated samples were prepared and forwarded to Onset Worldwide. One 1,000 g portion of the material remained untreated and held at Eurofins Microbiology Laboratories for pre-treatment analysis, while an additional 1,000 g portion was forwarded to Onset Worldwide for exposure to the above-mentioned apparatus or process. Both portions were tested for the following parameters: nutritional testing (NLEA Mandatory package with facts panel), percentage moisture (by AOAC 930.15), aerobic plate count (by AOAC 966.23), total coliform/E. coli (by AOAC 991.14), Staphylococcus aureus (by AOAC 975.55), and yeast and mold (by FDA-BAM Chapter 18). Samples were assessed both prior to and after treatment.

Results for each sample were converted to log₁₀ cfu/g. Results of the enumerations for the treated samples were compared to the untreated control samples to determine the effect of the inventive apparatus and process on the challenge organisms. The apparatus and process were deemed to be successful at controlling the challenge organism if each inoculum in a product was reduced by a minimum of 5.0 logs. Results for the treated and untreated chia seeds were also compared.

Results for the inoculated samples are shown in Table 2 below, including type of product, observed result (in cfu/g) for each replicate, the average result for all replicates, the log₁₀ of the average, and (for treated samples) the reduction (in log₁₀ cfu/g) from the untreated control.

TABLE 2
Challenge Study Results 2

| | | Hulled | | | |
|---|---|---|---|---|---|
| Sample Type | Chia Seeds | Hemp | Cashews | Milled Chia | Psyllium |
| Uninoculated | <10 | <10 | <10 | <10 | <10 |
| Sample 1 | | | | | |
| Uninoculated | <10 | <10 | <10 | <10 | <10 |
| Sample 2 | | | | | |
| Uninoculated | <10 | <10 | <10 | <10 | <10 |
| Sample 3 | | | | | |
| Average | <10 | <10 | <10 | <10 | <10 |
| (cfu/g) | | | | | |
| Pre-Treat | 2,900,000 | 7,700,000 | 4,700,000 | 3,100,000 | 4,200,000 |
| Sample 1 | | | | | |
| Pre-Treat | 8,400,000 | 8,600,000 | 4,400,000 | 8,400,000 | 7,800,000 |
| Sample 2 | | | | | |
| Pre-Treat | 4,300,000 | 6,000,000 | 7,100,000 | 4,000,000 | 6,200,000 |
| Sample 3 | | | | | |
| Average | 5,200,000 | 7,433,333 | 5,400,000 | 5,166,667 | 6,066,667 |
| (cfu/g) | | | | | |
| Log₁₀ | 6.72 | 6.87 | 6.73 | 6.71 | 6.78 |
| Post- | <10 | <10 | 20 | <10 | <10 |
| Treatment 1 | | | | | |
| Sample 1 | | | | | |
| Post- | <10 | <10 | 60 | <10 | <10 |
| Treatment 1 | | | | | |
| Sample 2 | | | | | |
| Post- | <10 | <10 | 10 | <10 | <10 |
| Treatment 1 | | | | | |
| Sample 3 | | | | | |
| Average | <10 | <10 | 30 | <10 | <10 |
| (cfu/g) | | | | | |
| Log₁₀ | <1.00 | <1.00 | 1.48 | <1.00 | <1.00 |
| Reduction | >5.72 | >5.87 | >5.26 | >5.71 | >5.78 |
| Post- | <10 | <10 | <10 | <10 | <10 |
| Treatment 2 | | | | | |
| Sample 1 | | | | | |
| Post- | <10 | <10 | <10 | <10 | <10 |
| Treatment 2 | | | | | |
| Sample 2 | | | | | |
| Post- | <10 | <10 | <10 | <10 | <10 |
| Treatment 2 | | | | | |
| Sample 3 | | | | | |
| Average | <10 | <10 | <10 | <10 | <10 |
| (cfu/g) | | | | | |
| Log₁₀ | <1.00 | <1.00 | <1.00 | <1.00 | <1.00 |
| Reduction | >5.72 | >5.87 | >5.73 | >5.71 | >5.78 |

### Conclusion

No E. coli was detected in the treated products, with the exception of low levels of E. coli detected after Treatment 1 in the cashew product. All post-treatment results for both treatment types showed reductions (in log₁₀ cfu/g) greater than the 5.0 standard, indicating that they were effective in reducing the generic E. coli surrogate for Salmonella and pathogenic E. coli. No background E. coli was detected on the uninoculated samples.

Results for the chia seed product pre- and post-treatment are shown in Table 3 below, including testing parameters and observed results both before and after treatment.

TABLE 3
Nutritional Value of Product

| | Before | After |
|---|---|---|
| Testing Parameter | Treatment | Treatment |
| Ash | 4.52% | 4.56% |
| Protein | 21.12% | 21.33% |
| Moisture | 7.5% | 7.6% |
| Total Fat | 30.80% | 30.81% |
| Carbohydrates | 36.06% | 35.70% |
| Calories | 506 kca1/100 g | 505 kcal/100 g |
| Dietary Fiber | 33.8% | 33.2% |
| Saturated Fatty Acids | 3.17% | 3.18% |
| Trans Fatty Acids | 0.04% | 0.04% |
| Polyunsaturated Fatty Acids | 23.90% | 23.91% |
| Monounsaturated Fatty Acids | 2.35% | 2.34% |
| Cholesterol | <0.8 mg/100 g | <0.8 mg/100 g |
| Sodium | <0.002% | <0.002% |
| Calcium | 0.660% | 0.659% |
| Potassium | 0.672% | 0.674% |
| Calories from Fat | 280 kcal/100 g | 280 kcal/100 g |
| Total Vitamin D2 and D3 | <4.00 IU/100 g | <4.00 IU/100 g |
| Vitamin D2 | <4.00 IU/100 g | <4.00 IU/100 g |
| Vitamin D3 | <4.00 IU/100 g | <4.00 IU/100 g |
| Aerobic Plate Count | 470 cfu/g | <10 cfu/g |
| Coliform/E. coli | <10 cfu/g | <10 cfu/g |
| Staphylococcus aureus | <10 cfu/g | <10 cfu/g |
| Yeast and Mold | 160 cfu/g | <10 cfu/g |

### Conclusion

No significant difference was observed in the nutritional values of the product before or after the treatment. Low levels of aerobic organisms and fungal organisms were observed in the product prior to treatment, but neither of these organisms was observed post-treatment. No coliforms or S. aureus were observed either before or after treatment.

Results from additional testing performed after a 4-month period of ambient storage are shown in Table 4, below.

TABLE 4
Post-Storage Results

| Testing Parameter | Untreated | Treated |
|---|---|---|
| Moisture | 6.4% | 6.1% |
| Peroxide Value | <2.0 meq/Kg | <2.0 meq/Kg |
| Aerobic Plate Count | 3,300 cfu/g | <10 cfu/g |
| Coliform/E. coli | <10 cfu/g | <10 cfu/g |
| Staphylococcus aureus | <10 cfu/g | <10 cfu/g |
| Yeast and Mold | 2,600 cfu/g | <10 cfu/g |

### Conclusion

After approximately 4 months of storage, a minor increase in aerobic plate count and yeast and mold count was observed in the untreated product, while the treated product continued to have no observable recovery for aerobic plate count, coliform/E. coli count, S. aureus, or yeast and mold. Both treated and untreated products appear to have lost minimal moisture (approximately 1%) from the beginning of storage, indicating that the general condition of the product is likely similar. The peroxide value had no observable result, indicating no rancidity was present in either product. Samples will be stored under accelerated conditions and reevaluated after a total of 6 months, 12 months, and 18 months to provide data corresponding to 1 year, 2 years, and 3 years of room temperature storage.

Additional sample sets (i.e., hulled hemp and sunflower seed products) were evaluated similarly to the initial set of samples. Results for the follow-up products are shown in Table 5, below.

TABLE 5
Follow-up Study Results

| Sample Type | Hulled Hemp | Sunflower Kernels |
|---|---|---|
| Uninoculated Sample 1 | <10 | <10 |
| Uninoculated Sample 2 | <10 | <10 |
| Uninoculated Sample 3 | <10 | <10 |
| Average (cfu/g) | <10 | <10 |
| Pre-Treat Sample 1 | 15,300,000 | 19,100,000 |
| Pre-Treat Sample 2 | 12,500,000 | 10,000,000 |
| Pre-Treat Sample 3 | 9,100,000 | 10,800,000 |
| Average (cfu/g) | 12,300,000 | 13,300,000 |
| Log₁₀ | 7.09 | 7.12 |
| Post-Treatment 1 Sample 1 | 10 | 160 |
| Post-Treatment 1 Sample 2 | 20 | 80 |
| Post-Treatment 1 Sample 3 | 20 | 140 |
| Average (cfu/g) | 17 | 127 |
| Log₁₀ | 1.22 | 2.10 |
| Reduction | 5.87 | 5.02 |
| Post-Treatment 2 Sample 1 | <10 | 10 |
| Post-Treatment 2 Sample 2 | <10 | 10 |
| Post-Treatment 2 Sample 3 | <10 | 20 |
| Average (cfu/g) | <10 | 13 |
| Log₁₀ | <1.00 | 1.12 |
| Reduction | >6.09 | 6.00 |

### Conclusion

Levels of E. coli were detected in both products after Treatment 1, but only in the sunflower kernel product after Treatment 2. However, all post-treatment results for both treatment types showed reductions (in log₁₀ cfu/g) greater than the 5.0 standard, indicating that they were effective in reducing the generic E. coli surrogate. No background E. coli was detected on the uninoculated samples.

The data in this study indicate that the above-mentioned apparatus and process were effective at controlling a surrogate for Salmonella spp. and pathogenic E. coli. Reductions against each matrix examined, including chia seeds, hulled hemp, cashews, defatted milled chia flour, psyllium powder, and sunflower seeds, were greater than 5.0 log₁₀ cfu/g post-exposure. No significant difference in nutritional values was observed in a representative product (chia seeds) before or after treatment.

It is understood that the details are illustrative, such that additional changes or modifications may be made by one with ordinary skills in the art, and still fall within the scope of this invention.

I claim:

1. An apparatus to decontaminate agricultural product utilizing ozone comprising:
an ozone generator, wherein the ozone generator delivers an ozone gas to a conveyor tube by means of an ozone generator pipe;
the ozone gas, upon entry into the conveyor tube, flows in two directions: towards a hopper and towards a discharge box;
a means for delivering the ozone gas to an ozone destructor;
a means for contacting the ozone gas with an agricultural product residing in the following three location: a hopper reservoir of the hopper, the conveyor tube, and the discharge box, wherein the contact is simultaneous;
a conveyor for transporting the agricultural product from the hopper to the discharge box;
the discharge box having a discharge transition connected to a perforated tube;
the agricultural product exiting the perforated tube has a 5-log or greater inactivation rate of surrogate organisms after treatment with the ozone gas.

2. The apparatus in claim 1, wherein the conveyor is a round screw conveyor, a beveled screw conveyor, or a puck conveyor;

3. The apparatus of claim 1, wherein concentration of the ozone gas in the conveyor tube is between 4,000 ppm and 24,000 ppm.

4. The apparatus of claim 1, wherein concentration of the ozone gas in the conveyor tube is 8,000 ppm.

5. The apparatus of claim 1, wherein the agricultural product is exposed to ozone gas between 5 and 60 seconds.

6. The apparatus of claim 1, wherein the hopper supports an agitator.

7. The apparatus of claim 1, wherein the conveyor tube supports a vibration motor.

8. An apparatus to decontaminate agricultural product utilizing ozone comprising:
an ozone generator in communication with a system controller, wherein the system controller has means to monitor and regulate flow of an ozone gas though a conveyor tube, a hopper, and a discharge box;
a conveyor housed within the conveyor tube, wherein said conveyor transports an agricultural product from the hopper to the discharge box;
the discharge box having means for connecting the conveyor, a conveyor motor, an ozone generator, and perforated tube;
a perforated tube attached to the discharge box at a discharge transition, wherein said discharge transition directs the agricultural product to a container;
one or more ozone destructor, wherein said ozone destructor catalyzes the ozone gas exiting a hopper exhaust port of the hopper or an ozone vent of the discharge box;
the agricultural product, following treatment, has a 5-log or greater inactivation rate of surrogate organisms.

9. The apparatus of claim 8, further comprising one or more duct hoses that deliver oxygen leaving the ozone destructor into an exhaust vent by means of an exhaust fan.

10. The apparatus of claim 8, wherein the duct hose is secured by a strap and a ceiling rod.

11. The apparatus in claim 8, wherein the conveyor is a round screw conveyor, a beveled screw conveyor, or a puck conveyor;

12. The apparatus of claim 8, wherein concentration of the ozone gas in the conveyor tube is between 4,000 ppm and 24,000 ppm.

13. The apparatus of claim 8, wherein concentration of the ozone gas in the conveyor tube is 8,000 ppm.

14. The apparatus of claim 8, wherein the agricultural product is exposed to ozone gas between 5 and 60 seconds.

15. The apparatus of claim 8, wherein the conveyor motor has a motor controller, wherein the motor controller is a variable frequency drive.

16. The apparatus of claim 8, further comprising a vibration motor.

17. The apparatus of claim 8, further comprising an agitator, having an agitator gasket that forms an airtight seal with the hopper, wherein said agitator mixes the agricultural product in a hopper reservoir by means of an agitator motor, an agitator shaft, and agitator blades;

18. The apparatus of claim 8, wherein the vibration motor is secured to the conveyor tube, wherein securing means include a bracket, a top cap, a bottom cap, and a plurality of fasteners.

19. The apparatus of claim 8, wherein a filter is attached to a hopper exhaust port of the hopper;

20. The apparatus of claim 8, wherein the ozone destructor houses a catalyst made of metal oxides, such as manganese dioxide or copper oxide.

21. The method to decontaminate agricultural product utilizing ozone comprising:
choosing a conveyor based on whether an agricultural product is a free-flowing product or a non-free-flowing product;
selecting a conveyor length and a conveyor speed, wherein the agricultural product has a transport duration in a conveyor tube between 5 and 60 seconds;
activating an ozone generator until concentration of the ozone gas in a conveyor tube reaches between 4,000 ppm and 24,000 ppm.
treating the agricultural product to achieve 5-log or greater inactivation rate of surrogate organisms.

22. The method of claim 21, wherein a round screw conveyor is chosen for the free-flowing product, wherein a beveled screw conveyor is chosen for flour, wherein a puck conveyor is chosen for fragile or delicate agricultural products.

23. The method of claim 21, wherein the transport duration in a conveyor tube is 10 seconds.

24. The method of claim 21, wherein concentration of the ozone gas in the conveyor tube is 8,000 ppm.

25. The method of claim 21, further comprising monitoring the ozone gas concentrations in a conveyor tube, a hopper, a discharge box, a perforated tube, or an exhaust vent.

26. The method of claim 21, further comprising waiting between 10 to 60 minutes, after deactivation of the ozone generator, before deactivating an exhaust fan.
